(19) United States
(12) Patent Application Publication
(10) Pub. No.: US 2024/0062106 A1
(43) Pub. Date: Feb. 22, 2024

(54) TIME-SERIES DATA PREDICTION APPARATUS, LEARNING APPARATUS, ESTIMATION APPARATUS, METHOD, AND PROGRAM

(71) Applicant: NIPPON TELEGRAPH AND TELEPHONE CORPORATION, Tokyo (JP)

(72) Inventors: Nobukazu FUKUDA, Musashino-shi, Tokyo (JP); Shingo HORIUCHI, Musashino-shi, Tokyo (JP); Chao WU, Musashino-shi, Tokyo (JP); Kenichi TAYAMA, Musashino-shi, Tokyo (JP)

(73) Assignee: NIPPON TELEGRAPH AND TELEPHONE CORPORATION, Tokyo (JP)

(21) Appl. No.: 18/269,570

(22) PCT Filed: Jan. 4, 2021
(86) PCT No.: PCT/JP2021/000034

§ 371 Date: Jun. 26, 2023

(51) Int. Cl. G06N 20/00

(52) U.S. Cl. CPC G06N 20/00

(57) ABSTRACT

A time-series data prediction device according to an embodiment acquires a second spatial factor that is a spatial factor related to entire space related to geographically and spatially dispersed time-series data, updates various factors based on time-series data, a spatial model, and a loss function of a temporal model, updates parameters of the space and the temporal model, inputs region data indicating a geographical region related to geographically and spatially dispersed second time-series data to be estimated for future time-series data, acquires a spatial factor that is a spatial factor related to entire space related to the second time-series data, updates various factors based on the second time-series data, the spatial model, and the loss function of the temporal model, updates various factors based on an update result, predicts a future temporal factor, and estimates future time-series data using the predicted temporal factor.

### TECHNICAL FIELD

Embodiments of the present invention relate to a time-series data prediction device, a learning device, an estimation device, a method, and a program.

### BACKGROUND ART

In order to predict (estimate or infer) geographically and spatially dispersed time-series data, for example, a rainfall amount or a traffic amount, with high accuracy, a spatiotemporal model in which a temporal factor and a spatial factor are simultaneously handled is required.

As a spatiotemporal model, for example, as disclosed in Non Patent Literature 1, there is a model that captures a correlation between data in a temporal direction and a spatial direction.

In addition, as a method of enhancing the resolution of social information, for example, as disclosed in Non Patent Literature 2, there is a method of enhancing the resolution of data having a coarse granularity based on social information data having a plurality of different granularities at a time point.

### CITATION LIST

### Non Patent Literature

Non Patent Literature 1: Takeuchi K et al., Autoregressive tensor factorization for spatio-temporal predictions, In ICDM 2017
Non Patent Literature 2: Tanaka Y et al., Spatially Aggregated Gaussian Processes with Multivariate Areal Outputs, In NeurIPS2019

### SUMMARY OF INVENTION

### Technical Problem

In a method like that disclosed in Non Patent Literature 1, the space in the spatiotemporal model is regarded as a point, and the time-series data aggregated at each point in the space is predicted, and therefore highly accurate prediction of the time-series data in the region is not realized.

In addition, a method like that disclosed in Non Patent Literature 2 cannot be applied to time-series data.

The present invention has been made in view of the above circumstances, and an object thereof is to provide a time-series data prediction device, a learning device, an estimation device, a method, and a program capable of predicting geographically and spatially dispersed time-series data with high accuracy.

### Solution to Problem

The time-series data prediction device according to an aspect of the present invention is a time-series data prediction device including a first input unit that inputs geographically and spatially dispersed first time-series data, a second input unit that inputs first region data indicating a geographical region, the first region data being related to the first time-series data input by the first input unit, an initialization unit that performs initialization processing of a first spatial factor and a first temporal factor by decomposing the first time-series data input by the first input unit into the first spatial factor that is a spatial factor indicating a space related to the first time-series data and the first temporal factor that is a temporal factor indicating a time related to the first time-series data, an acquisition unit that acquires a second spatial factor that is a spatial factor related to an entire space, acquires a parameter of a spatial model that inputs the first spatial factor and the first region data and outputs a second spatial factor obtained by adding the first region data to the first spatial factor, and acquires a parameter of a temporal model that inputs the first temporal factor and outputs a future temporal factor, a first update unit that updates the first spatial factor initialized by the initialization unit, the first temporal factor initialized by the initialization unit, and the second spatial factor acquired by the acquisition unit based on a loss function of the first time-series data, a loss function of the spatial model, and a loss function of the temporal model, updates a parameter of the spatial model based on the loss function of the spatial model, and updates the parameter of the temporal model based on the loss function of the temporal model, a third input unit that inputs geographically and spatially dispersed second time-series data to be estimated for future time-series data, a fourth input unit that inputs second region data indicating a geographical region, the second region data being related to the second time-series data input by the third input unit, a second initialization unit that performs initialization processing of a third spatial factor and a second temporal factor by decomposing the second time-series data input by the third input unit into the third spatial factor that is the spatial factor indicating a space related to the second time-series data and the second temporal factor that is a temporal factor indicating a time related to the second time-series data, a second acquisition unit that acquires a fourth spatial factor related to the second time-series data, the fourth spatial factor being a spatial factor related to an entire space, a second update unit that updates (1) the initialized third spatial factor, (2) the initialized second temporal factor, and (3) the acquired fourth spatial factor based on a loss function of the second time-series data, a loss function of the spatial model based on a parameter of the spatial model updated by the first update unit and the second spatial factor updated by the first update unit, and a loss function of the temporal model based on a parameter of the temporal model updated by the first update unit, and an estimation unit that predicts a future temporal factor based on a result updated by the second update unit and estimates the future time-series data based on the predicted temporal factor and the third spatial factor updated by the second update unit.

The learning device according to an aspect of the present invention is a learning device including a first input unit that inputs geographically and spatially dispersed first time-series data, a second input unit that inputs first region data indicating a geographical region, the first region data being related to the first time-series data input by the first input unit, an initialization unit that performs initialization processing of the first spatial factor and the first temporal factor by decomposing the first time-series data input by the first input unit into a first spatial factor that is a spatial factor indicating a space related to the first time-series data and a first temporal factor that is a temporal factor indicating a time related to the first time-series data, an acquisition unit that acquires a second spatial factor that is a spatial factor related to an entire space, acquires a parameter of a spatial model that inputs the first spatial factor and the first region data and outputs a second spatial factor obtained by adding the first region data to the first spatial factor, and acquires a parameter of a temporal model that inputs the first temporal factor and outputs a future temporal factor, and an update unit that updates the first spatial factor initialized by the initialization unit, the first temporal factor initialized by the initialization unit, and the second spatial factor acquired by the acquisition unit based on a loss function of the first time-series data, a loss function of the spatial model, and a loss function of the temporal model, updates a parameter of the spatial model based on a loss function of the spatial model, and performs learning processing of updating a parameter of the temporal model based on a loss function of the temporal model.

The time-series data prediction method according to an aspect of the present invention is a time-series data prediction method performed by a time-series data prediction device, the time-series data prediction method including inputting geographically and spatially dispersed first time-series data, inputting first region data indicating a geographical region, the first region data being related to the input first time-series data, performing first initialization that is initialization of a first spatial factor and a first temporal factor by decomposing the input first time-series data input into the first spatial factor that is a spatial factor indicating a space related to the first time-series data and the first temporal factor that is a temporal factor indicating a time related to the first time-series data, acquiring a second spatial factor that is a spatial factor related to an entire space, acquiring a parameter of a spatial model that inputs the first spatial factor and the first region data and outputs a second spatial factor obtained by adding the first region data to the first spatial factor, and acquiring a parameter of a temporal model that inputs the first temporal factor and outputs a future temporal factor, updating the initialized first spatial factor, the initialized first temporal factor, and the acquired second spatial factor based on a loss function of the first time-series data, a loss function of the spatial model, and a loss function of the temporal model, updating a parameter of the spatial model based on the loss function of the spatial model, and updating the parameter of the temporal model based on the loss function of the temporal model, inputting geographically and spatially dispersed second time-series data to be estimated for future time-series data, inputting second region data indicating a geographical region, the second region data being related to the second time-series data, performing second initialization that is initialization of a third spatial factor and a second temporal factor by decomposing the second time-series data into the third spatial factor that is the spatial factor indicating a space related to the second time-series data and the second temporal factor that is a temporal factor indicating a time related to the second time-series data, acquiring a fourth spatial factor related to the second time-series data, the fourth spatial factor being a spatial factor related to an entire space, updating (1) the initialized third spatial factor, (2) the initialized second temporal factor, and (3) the acquired fourth spatial factor based on a loss function of the second time-series data, a loss function of the spatial model based on a parameter of the updated spatial model and the updated second spatial factor, and a loss function of the temporal model based on a parameter of the updated temporal model, and predicting a future temporal factor based on a result updated and estimating the future time-series data based on the predicted temporal factor and the updated third spatial factor.

### Advantageous Effects of Invention

According to the present invention, geographically and spatially dispersed time-series data can be predicted with high accuracy.

### BRIEF DESCRIPTION OF DRAWINGS

FIG. 1 is a block diagram illustrating an application example of a time-series data prediction device according to an embodiment of the present invention.

FIG. 2 is a diagram illustrating an example of time-series data.

FIG. 3 is a diagram illustrating an example of a spatiotemporal model.

FIG. 4 is a diagram illustrating an example of input/output at the time of training in a general spatial model.

FIG. 5 is a diagram illustrating an example of map data input at the time of training in a general spatial model.

FIG. 6 is a diagram illustrating an example of an output result at the time of training in a general spatial model.

FIG. 7 is a diagram illustrating an example of input/output at the time of inference in a general spatial model.

FIG. 8 is a diagram illustrating an example of training of a spatial model in the time-series data prediction device according to an embodiment of the present invention.

FIG. 9 is a diagram illustrating an example of a background spatial factor used for a spatial model in the time-series data prediction device according to an embodiment of the present invention.

FIG. 10 is a diagram illustrating an example of an output result from the spatial model in the time-series data prediction device according to an embodiment of the present invention.

FIG. 11 is a diagram illustrating an example of inference of the spatial model in the time-series data prediction device according to an embodiment of the present invention.

FIG. 12 is a diagram illustrating an example of a spatial granularity of input/output data at the time of training in the spatial model.

FIG. 13 is a diagram illustrating an example of the spatial granularity of input/output data at the time of inference in the spatial model.

FIG. 14 is a diagram illustrating an example of a region before change in time-series data.

FIG. 15 is a diagram illustrating an example of a region after change in time-series data.

FIG. 16 is a diagram illustrating an example of prediction accuracy in a tabular format.

FIG. 17 is a block diagram illustrating an example of a hardware configuration of the time-series data prediction device according to an embodiment of the present invention.

### DESCRIPTION OF EMBODIMENTS

An embodiment according to the present invention will be described below with reference to the drawings.

In a time-series data prediction device according to an embodiment of the present invention, a model that performs planar estimation for each designated region is newly introduced into a module that handles a spatial factor in a spatiotemporal model, and time-series data in an arbitrary designated region can be predicted.

As a result, it is possible to predict time-series data having spatially different aggregation granularity with high accuracy. In addition, even if the number, aggregation range, or the like of sensors corresponding to input data is changed due to a change in the system or the like, the trained (learned) model can be reused.

A temporal factor and a spatial factor are obtained as data in which the spatiotemporal data is decomposed into a temporal direction and a spatial direction. In the above planar estimation in the present embodiment, the background spatial factor, which is a spatial factor distributed in the entire space, that is, related to the entire space, is trained without depending on the division of each region.

At the time of inference after training, the time-series data prediction device aggregates the spatial factor of each region by surface-integrating the background spatial factor according to a designated region.

As an application example of the present embodiment, the time-series data prediction device inputs time-series data indicating a transition of the number of passengers of a taxi counted at a specific point in an area having a finer spatial granularity to a model trained from time-series data indicating a transition of the number of passengers of the taxi counted in each area, for example, and predicts the future of the number of passengers of the taxi at this point. As a result, the time-series data in the region on the space is predicted.

In the present embodiment, a mechanism for performing spatial aggregation in a spatial model included in a spatiotemporal model is introduced. In the present embodiment, the background spatial factor distributed on the map is trained instead of the spatial factor corresponding to the point where the time-series data is aggregated. By aggregating the trained background spatial factors in a specified region, time-series prediction according to the region is possible. As a result, it is possible to analyze time-series data in a designated arbitrary region.

In the present embodiment, time-series data of geographically dispersed sensor data or social information is associated on a map, so that time-series prediction with a spatial granularity different from that at the time of training the model can be performed.

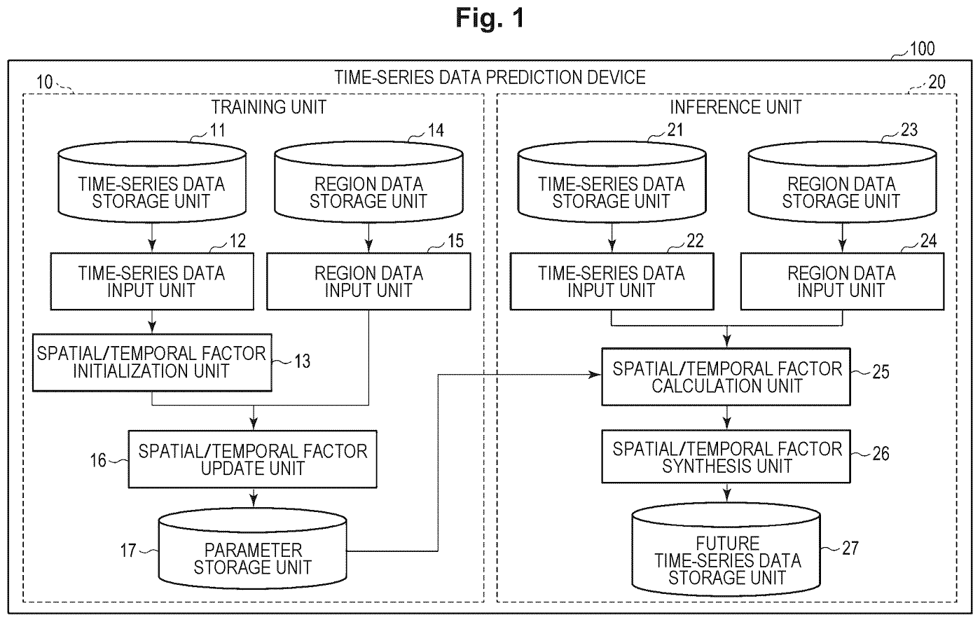

FIG. 1 is a block diagram illustrating an application example of the time-series data prediction device according to an embodiment of the present invention.

As illustrated in FIG. 1, a time-series data prediction device 100 according to an embodiment of the present invention includes a training unit (also referred to as a learning unit) 10 and an inference unit (also referred to as a prediction unit or an estimation unit) 20.

The training unit 10 includes a time-series data storage unit 11, a time-series data input unit 12, a spatial/temporal factor initialization unit 13, a region data storage unit 14, a region data input unit 15, a spatial/temporal factor update unit 16, and a parameter storage unit 17.

The inference unit 20 includes a time-series data storage unit 21, a time-series data input unit 22, a region data storage unit 23, a region data input unit 24, a spatial/temporal factor calculation unit 25, a spatial/temporal factor synthesis unit 26, and a future time-series data storage unit 27. Processing and the like of each unit will be described later. Furthermore, the training unit 10 and the inference unit 20 in the time-series data prediction device 100 may be separate devices, for example, a training device (also referred to as a learning device) and an inference device (also referred to as a prediction device or an estimation device).

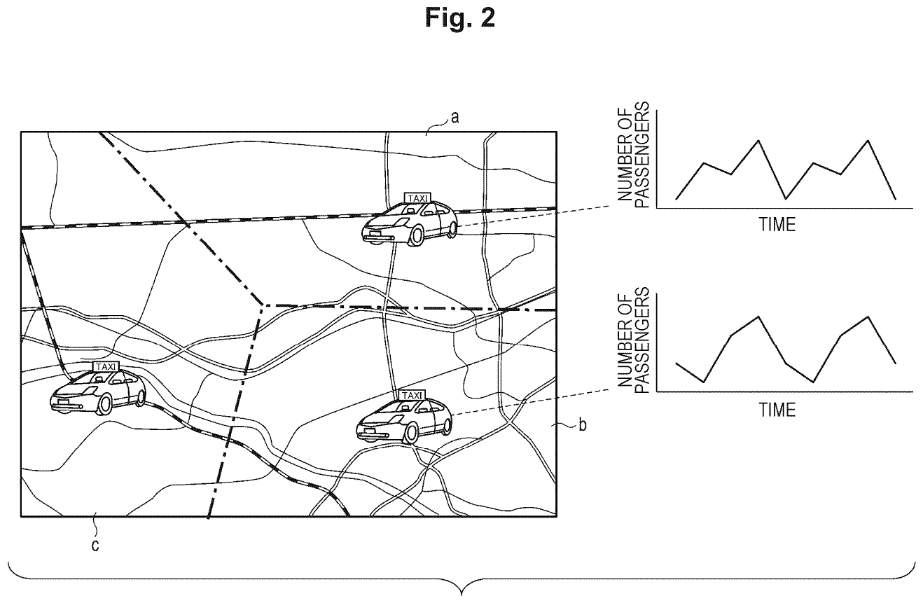

FIG. 2 is a diagram illustrating an example of time-series data.

Here, the number of passengers per hour of a taxi in each area is shown. In FIG. 2, an area A indicated by a symbol a, an area B indicated by a symbol b, and an area C indicated by a symbol c are illustrated, and there are time-series data of the number of passengers in a taxi traveling in the area A and time-series data of a total value of the number of passengers in a taxi traveling in the area B. Although illustration is omitted, the same applies to the above-described area C. Here, the number of passengers on a taxi in each area is a total value of the number of passengers on each taxi traveling in the same area and belonging to the same taxi company.

The time-series data of the number of passengers in a taxi in the area A can indicate that a total value of the number of passengers in a taxi in a predetermined time zone, for example, a total value of the number of passengers in a taxi between 10:00 and 11:00 in the area A, is 10 people.

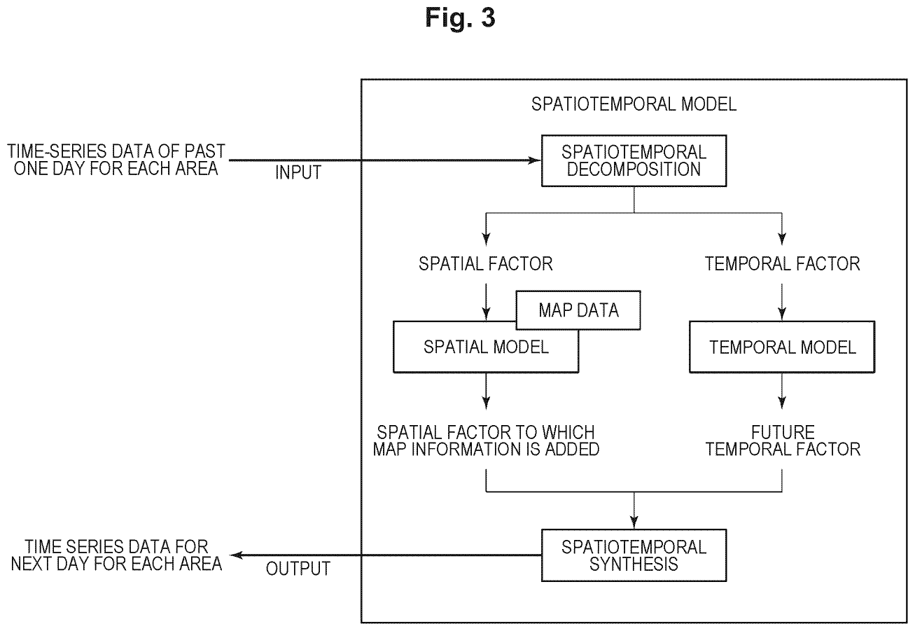

FIG. 3 is a diagram illustrating an example of a spatiotemporal model.

Here, a spatiotemporal model used at the time of inference of the time-series data is illustrated.

In the spatiotemporal model, time-series data of the past one day for each area is input, and the time-series data is decomposed into a spatial factor and a temporal factor by spatiotemporal decomposition.

The temporal factor is input to a temporal model included in the spatiotemporal model, and a future temporal factor is output from the temporal model.

In addition, the spatial factor is input together with the map data to the spatial model included in the spatiotemporal model, and the spatial factor to which the map information is added is output from the spatial model.

The output result from the temporal model and the output result from the spatial model are converted into the time-series data for the next day in each area by spatiotemporal synthesis and output from the spatiotemporal model.

Next, details of input and output in the spatial model will be described. Here, in order to facilitate understanding of an embodiment of the present invention, input/output in a conventionally used general spatial model and input/output in a spatial model according to an embodiment of the present invention will be described.

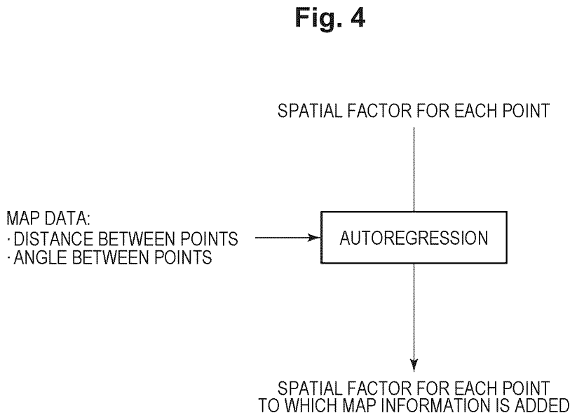

First, input/output in a conventionally used general spatial model will be described. FIG. 4 is a diagram illustrating an example of input/output at the time of training in a general spatial model.

Here, existing Directed autoregressive (DAR) is used. This technique is a technique of performing autoregression on a spatial factor corresponding to an input point.

In the example illustrated in FIG. 4, at the time of training, the spatial factor for each point is input to the autoregressive model of the spatial model together with the map data. In this map data, a distance between points in a region of the map data and an angle between points are indicated, and a center of gravity of the region is calculated as a representative point of the region.

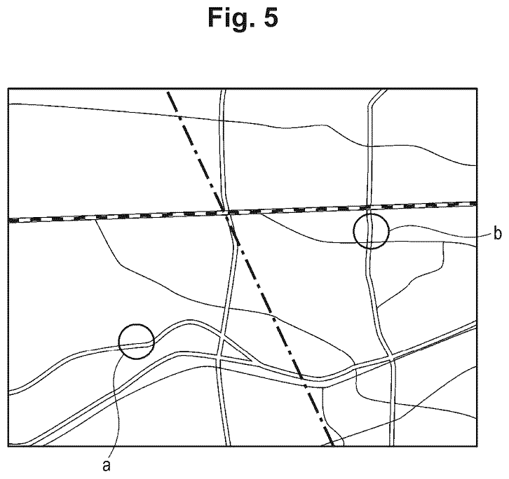

FIG. 5 is a diagram illustrating an example of map data input at the time of training in a general spatial model.

In FIG. 5, the input result to the spatial model in which the representative point a of a first area (region) and the representative point b of a second area are shown is shown.

From the autoregressive model of the spatial model, the spatial factor for each point to which the map information is added is output.

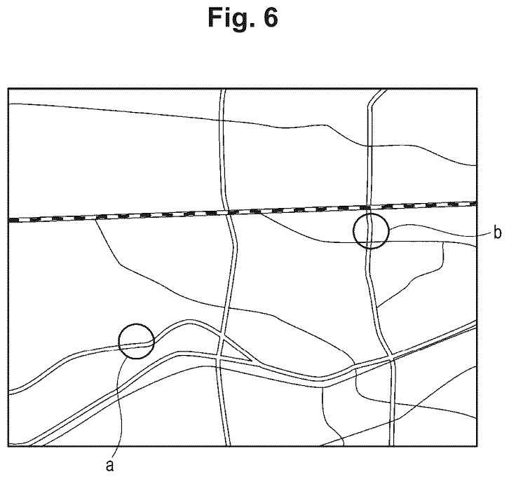

Then, in the autoregressive model, the weights related to the distance and the angle are trained by autoregression so that input and output in the autoregressive model become equal. FIG. 6 is a diagram illustrating an example of an output result at the time of training in a general spatial model. In FIG. 6, an output result equal to the input result illustrated in FIG. 5 by the autoregression is illustrated.

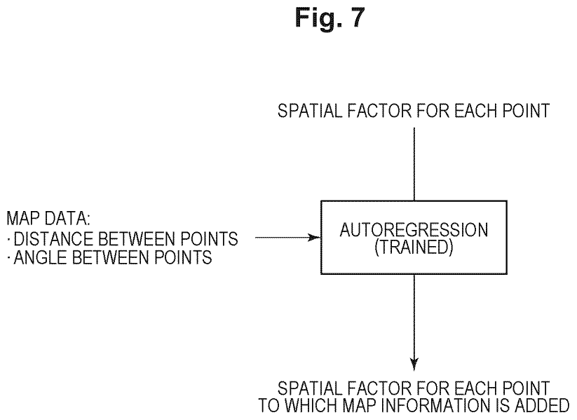

FIG. 7 is a diagram illustrating an example of input/output at the time of inference in a general spatial model.

Here, the above-described DAR is used.

In the example illustrated in FIG. 7, at the time of inference, the spatial factor for each point is input to the trained autoregressive model together with the map data. In this map data, a distance between points in a region of the map data and an angle between points are indicated, and a center of gravity of the region is calculated as a representative point of the region.

From the autoregressive model, the spatial factor for each point to which the map information is added is output.

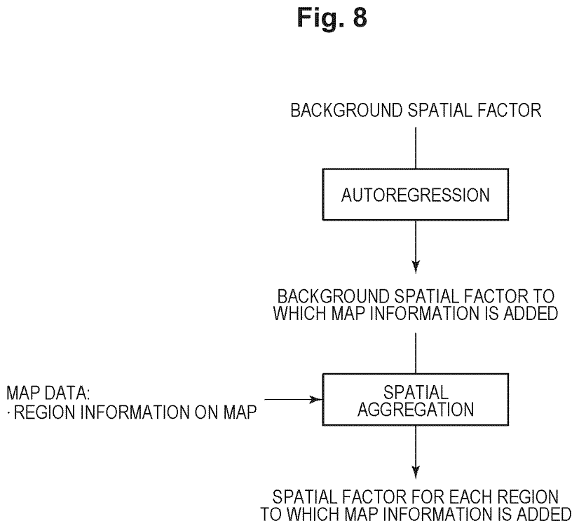

Next, input and output in the spatial model according to an embodiment of the present invention will be described. FIG. 8 is a diagram illustrating an example of training of a spatial model in the time-series data prediction device according to an embodiment of the present invention.

Here, spatially aggregated autoregressive regularization (SAAR) different from the conventional technique is used. This technique is a technique of calculating a spatial factor for each region by performing autoregression on a background spatial factor of the entire space and aggregating the background spatial factors.

The conventional DAR and the SAAR according to an embodiment of the present invention are different in processing inside the spatial model. In an embodiment of the present invention, a background spatial factor that is independent of region division is introduced to perform inference on any region.

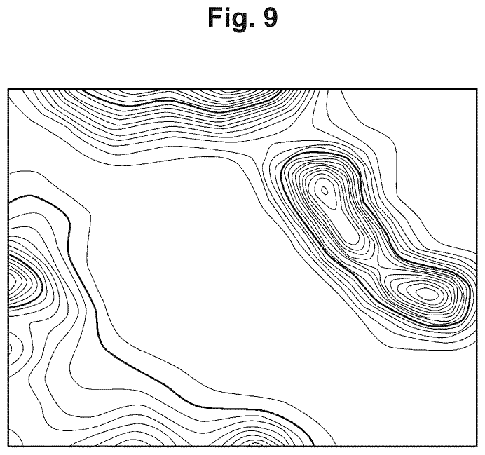

In the example illustrated in FIG. 8, at the time of training, the background spatial factor is initialized to random and input to the autoregressive model of the spatial model. FIG. 9 is a diagram illustrating an example of a background spatial factor used for a spatial model in the time-series data prediction device according to an embodiment of the present invention. In this FIG. 9, an example of a randomly initialized background spatial factor is illustrated.

The output result from the autoregressive model of the spatial model is input to the spatial aggregation model of the spatial model together with the map data. In this map data, region information on the map in the region of the map data is indicated.

From the spatial aggregation model of the spatial model, the spatial factor for each region to which the map information is added is output as an output result of the entire spatial model by spatial aggregation, here, aggregation of the spatial factor of each region by the surface integral along the designated region.

Based on the output result, in the above autoregressive model, the weights of the background spatial factors are trained by autoregression so that input and output in the autoregressive model become equal. As a result, the background spatial factor to which the map information is added is output from the autoregressive model and input to the spatial aggregation model. In the above autoregressive model, the background spatial factor is trained such that the position information of the background spatial factor is equal to the position information of each point on the map data.

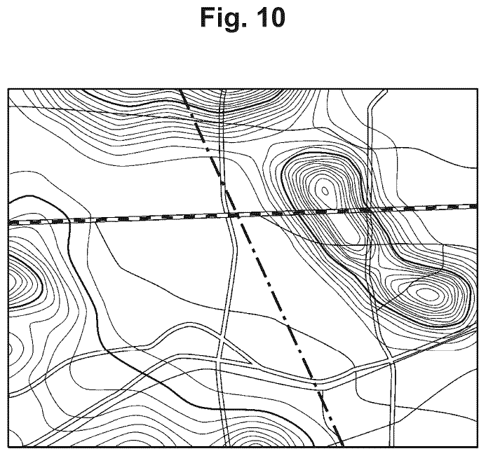

FIG. 10 is a diagram illustrating an example of an output result from the spatial model in the time-series data prediction device according to an embodiment of the present invention. FIG. 10 illustrates an example of a result of training the background spatial factor so that the position information of the background spatial factor is equal to the position information for each point on the map data.

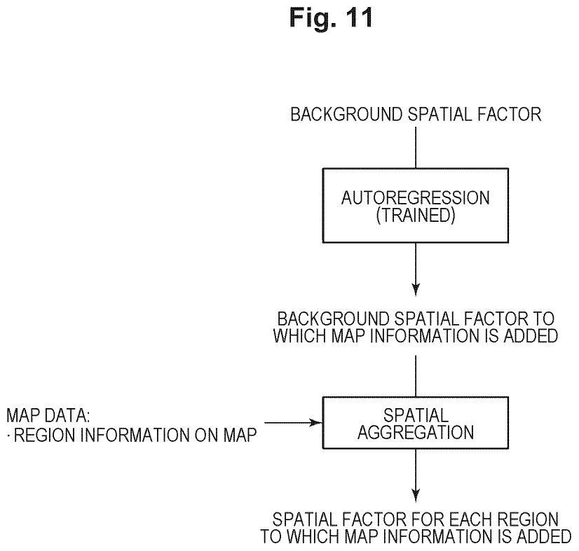

FIG. 11 is a diagram illustrating an example of inference of the spatial model in the time-series data prediction device according to an embodiment of the present invention.

Here, the above-described SAAR is used.

In the example illustrated in FIG. 11, at the time of inference, the trained background spatial factor is input to the trained autoregressive model. From this autoregressive model, the background spatial factor to which the map information is added is input to the spatial aggregation model of the spatial model together with the map data. In this map data, region information on the map in the region of the map data is indicated.

From the spatial aggregation model of the spatial model, a spatial factor for each designated region to which map information is added is output as an output result of the entire spatial model by spatial aggregation. Here, the designated region does not depend on the division result of the region at the time of training.

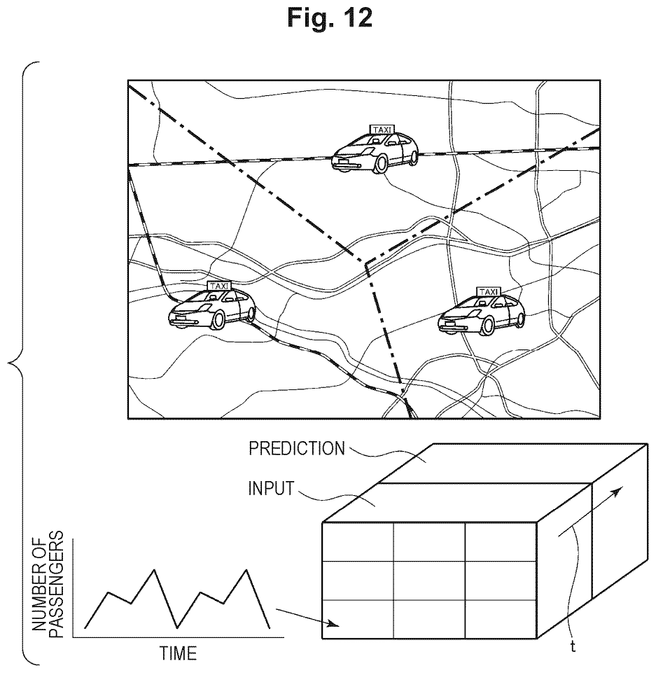

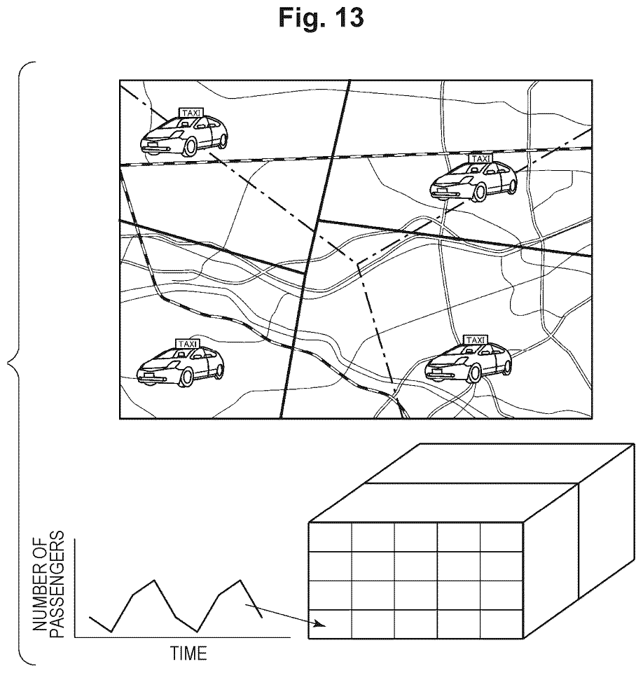

Next, comparison between input/output data at the time of training and input/output data at the time of inference in the spatial model will be described. FIG. 12 is a diagram illustrating an example of a spatial granularity of input/output data at the time of training in the spatial model. FIG. 13 is a diagram illustrating an example of the spatial granularity of input/output data at the time of inference in the spatial model.

In FIGS. 12 and 13, it is indicated that the characteristic of each area changes as the aggregation source area in the time-series data of each area is subdivided and the area changes from the time of training to the time of inference.

The subdivision refers to, for example, that the division of the area at the time of training is a commercial area, whereas the division of the area at the time of inference is subdivided from, for example, an area around a shopping mall having a finer spatial granularity than the commercial area to a division of the area according to each periphery of a supermarket. Such a correspondence relationship between the area before the change and the area after the change is not obvious.

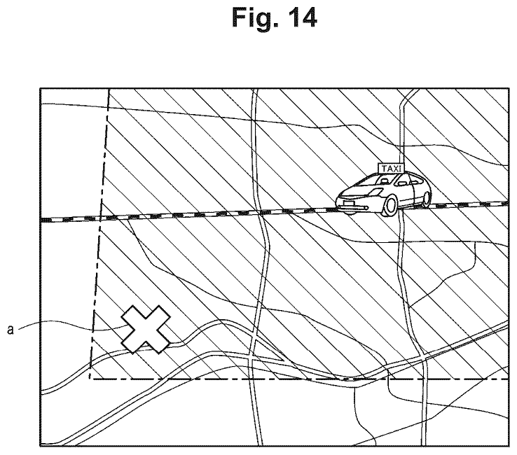

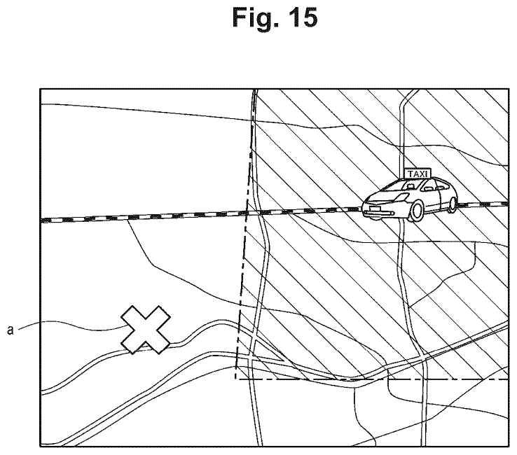

FIG. 14 is a diagram illustrating an example of a region before change in time-series data. FIG. 15 is a diagram illustrating an example of a region after change in time-series data.

In the example illustrated in FIG. 14, an office building denoted by reference sign a is located in an area to be counted for the number of passengers in a taxi. On the other hand, in the example illustrated in FIG. 15 in which the area for which the number of passengers in a taxi is counted is changed, an office building denoted by reference sign a is located outside the area for which the number of passengers in a taxi is counted.

In an embodiment of the present invention, as described above, even when the area to be aggregated of the time-series data is changed, the future time-series data in the area after the change can be predicted.

Next, an example by the time-series data prediction device according to an embodiment of the present invention will be described.

This set of time-series data is assumed to be taxi passenger count data for each area in the City of New York.

In addition, in this embodiment, the prediction accuracy when each of the evaluation models corresponding to the following (1), (2), and (3) is used is compared.
(1) Temporal Regularized Tensor Factorization (TRTF): Model obtained by removing a spatial model from an existing spatiotemporal model
(2) Spatio-Temporal Regularized Tensor Factorization with DAR (STRTF w/DAR): Existing spatiotemporal model
(3) Spatio-Temporal Regularized Tensor Factorization with Spatially Aggregated Autoregressive (STRTF w/SAAR): Evaluation model used in an embodiment of the present invention

An evaluation method in this embodiment will be described.

The spatial granularity at the time of training the spatial model, the period from the input of the time-series data to the output of the prediction result, the input date and time, and the output date and time are as follows.

Space particle size: 8 (Borough)

Period from input to output: Jun. 1-Jun. 9, 2019

Input date and time: Jun. 1, 2019-Jun. 8, 2019, Output date and time: Jun. 9, 2019

The spatial granularity, the period from input to output, the input date and time, and the output date and time at the time of inference evaluation by the spatial model are as follows.

Space particle size: 256 (aggregation section)

Period from input to output: Jun. 14-Jun. 22, 2019

Input date and time: Jun. 14, 2019, Output date and time: Jun. 15, 2019 . . . . Input date and time: Jun. 21, 2019, Output date and time: Jun. 22, 2019

Here, seven times of input and output are performed.

In addition, it is assumed that 128 sections randomly selected in the input data are missing.

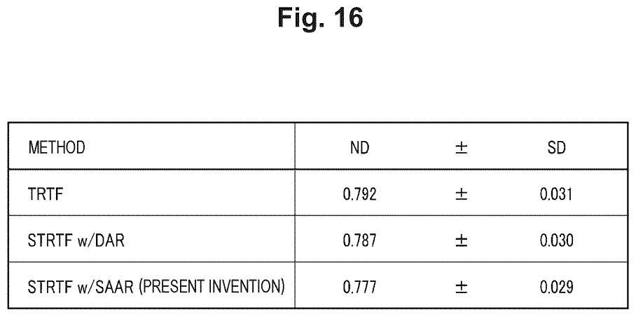

FIG. 16 is a diagram illustrating an example of prediction accuracy in a tabular format.

In the example illustrated in FIG. 16, a normalized deviation (ND) and a standard deviation (SD) in each of the above “TRTF”, “STRTF w/DAR”, and “STRTF w/SAAR” are illustrated.

This normalized deviation (ND) is an evaluation index of prediction of time-series data, and the lower this value, the better the prediction accuracy. In addition, here, the standard deviation (SD) is a standard deviation of the normalized deviation (ND) in the seven times of input/output.

The example illustrated in FIG. 16 illustrates that the prediction accuracy when “STRTF w/SAAR” used in an embodiment of the present invention is superior to the prediction accuracy when known “TRTF” and “STRTF w/DAR” are used.

Normalized deviation (ND) is expressed by Equation (1) below.

$$\begin{matrix}[ Math . 1 ] & \\ ND = \frac{{\sum }_{i} \vert {\hat{y}}_{i} - {y}_{i} \vert}{{\sum }_{i} \vert {y}_{i} \vert} & Equation ( 1 )\end{matrix}$$

The expression

ŷᵢ [Math. 2]

in Equation (1) is the predicted value of the time-series data, and yᵢ is the observed value (input value) of the time-series data.

In addition, the Standard deviation (SD) is expressed by Equation (2) below.

$$\begin{matrix}[ Math . 3 ] & \\ {SD}^{2} = \frac{1}{7} {\sum }_{d}^{7} {( {ND}_{d} - \overline{ND} )}^{2} & Equation ( 2 )\end{matrix}$$

d in this Equation (2) is a variable from the first time to the seventh time of the seven times.

Next, an example of a processing algorithm by the training unit 10 of the time-series data prediction device 100 will be described.

Various input data in the training unit 10 are the following (a) to (f). The initial values of the rank, the background spatial factor, and the parameters of the various models, which are (b) and (d) to (f) below, may be given from the outside, or may be stored in advance in the parameter storage unit 17 in the time-series data prediction device 100 or another storage device (not illustrated) in the device.
(a) Geographically and spatially distributed time-series data

Y∈ [symbol] ^{L×T} [Math. 4]
(b) Rank of tensor in natural number

R∈ [symbol] [Math. 5]
(c) Region data indicating a region on a map related to the time-series data.

A∈ [symbol] ^{L×W×H} [Math. 6]
(d) Initial value of background spatial factor

X∈ [symbol] ^{R×W×H} [Math. 7]
(e) Initial value of parameter θ_{S} of spatial model
(f) Initial value of parameter θT of temporal model

L in the notation of the time-series data and the like means the above region, for example, an area where the number of passengers in a taxi is counted, and T in the notation of the time-series data and the like means time. The right side of the notation of the time-series data is a set of real numbers over the above region and time.

W of the region data or the like means the width of the region, and H of the region data or the like means the height of the region. The right side of the notation of the region data is a set of real numbers over the region, width, and height.

The time-series data is stored in the time-series data storage unit 11 and acquired by the time-series data input unit 12. The region data is stored in the region data storage unit 14 and acquired by the region data input unit 15.

In addition, various output data, which are data after training for the input data in the training unit 10, are the parameter θ_{S} of the spatial model, the parameter θ_{T} of the temporal model, and a background spatial factor X. Here, the spatial model is a model that inputs a spatial factor and region data and outputs a background spatial factor to which the region data is added, and the temporal model is a model that inputs a temporal factor and outputs a future temporal factor.

The training unit 10 performs the following processing of (1) to (4) so that the output data can be obtained for the input data. However, the processing of (2) to (4) is repeated by a predetermined number of epoch.
(1) The spatial/temporal factor initialization unit 13 of the training unit 10 performs initialization processing of a spatial factor U₁ and a temporal factor U₂ by performing CP decomposition (Canonical Polyadic Decomposition) of time-series data Y acquired by the time-series data input unit 12 into the spatial factor U₁ and the temporal factor U₂ as in Equation (3) below.

Y=U₁·U₂ Equation (3)
(2) Next, according to Equations (4), (5), and (6) below, the spatial/temporal factor update unit 16 updates the factor U obtained by synthesizing the spatial factor U₁ and the temporal factor U₂ and the background spatial factor X, respectively based on the loss function of

[symbol]

_{F} [Math. 8]

of the matrix decomposition of the time-series data, the loss function of

[symbol]

_{S} [Math. 9]

of the spatial model, and the loss function of

[symbol]

_{T} [Math. 10]

of the temporal model.

The left side of Equation (4) corresponds to the entire loss function, the first term of the right side of Equation (4) corresponds to the loss function of the matrix decomposition of the time-series data, the second term of the right side of Equation (4) corresponds to the loss function of the spatial model, and the third term of the right side of Equation (4) corresponds to the loss function of the temporal model.

$$\begin{matrix}[ Math . 11 ] & \\ ℒ = {ℒ}_{F} ( \hat{Y} , Y ) + {ℒ}_{S} ( {τ}_{S} ( X , A , {Θ}_{S} ) , {U}_{1} ) + {ℒ}_{T} ( {τ}_{T} ( {U}_{2} , {Θ}_{T} ) , {U}_{2} & Equation ( 4 )\end{matrix}$$

$$U ← U + \frac{\partial }{\partial U} ℒ \qquad Equation ( 5 )$$

$$X ← X + \frac{\partial }{\partial U} ℒ \qquad Equation ( 6 )$$

The below expression of the first term on the right side of Equation (4) corresponds to future time-series data:

Ŷ [Math. 12]

In addition, τ_{S} of the second term on the right side of Equation (4) corresponds to the autoregressive model in the spatial model, and τ_{T} of the third term on the right side of Equation (4) corresponds to the autoregressive model in the temporal model.
(3) The spatial/temporal factor update unit 16 updates the initial value of the parameter Θ_{S} of the spatial model stored in, for example, the parameter storage unit 17 according to Equation (7) below based on the loss function of the spatial model, and stores the updated parameter in the parameter storage unit 17.

$$\begin{matrix}[ Math . 13 ] & \\ {Θ}_{S} ← {Θ}_{S} + \frac{\partial }{\partial {Θ}_{S}} {ℒ}_{S} ( {τ}_{S} ( X , A , {Θ}_{S} ) , {U}_{1} ) & Equation ( 7 )\end{matrix}$$

The spatial model “τ_{S} (X, A, Θ_{S})” of the above Equation (7) can be expressed by Equation (8) below. τ's in Equation (8) is an autoregressive model in the spatial model, and may be the same model as the above τ_{S}. Further, [Math. 14] in Equation (8) is the future background spatial factor.

\hat{X} [Math. 14]

In addition, l, w, h, and r in Equation (8) correspond to L, W, H, and R described above.

$$\begin{matrix}[ Math . 15 ] & \\ {τ}_{S} ( X , A , {Θ}_{S} ) = {\sum }_{w , h} {{[ A ]}_{l , w , h} [ \hat{X} ]}_{r , w , h} = {\sum }_{w , h} {[ A ]}_{l , w , h} {τ}_{S}^{′} ( X , {Θ}_{S} ) & Equation ( 8 )\end{matrix}$$

(4) Next, the spatial/temporal factor update unit 16 updates the initial value of the parameter Θ_{T} of the temporal model stored in, for example, the parameter storage unit 17 according to Equation (9) below based on the loss function of the temporal model, and stores the updated parameter in the parameter storage unit 17. As described above, the processing by the training unit 10 of the time-series data prediction device 100 ends.

$$\begin{matrix}[ Math . 16 ] & \\ {Θ}_{T} ← {Θ}_{T} + \frac{\partial }{\partial {Θ}_{T}} {ℒ}_{T} ( {τ}_{T} ( {U}_{2} , {Θ}_{T} ) , {U}_{2} ) . & Equation ( 9 )\end{matrix}$$

Next, an example of a processing algorithm by the inference unit 20 of the time-series data prediction device 100 will be described.

The various input data in the inference unit 20 are (a) geographically and spatially dispersed time-series data that is an estimation target of future time-series data, (b) a rank of a tensor in a natural number, (c) region data indicating a region on a map related to the corresponding time-series data, (d) an initial value of a background spatial factor that is a spatial factor related to the entire space related to the corresponding time-series data, (e) a parameter of a spatial model, and (f) a parameter of a temporal model. The initial value of the background spatial factor, the parameter of the spatial model, and the initial value of the parameter of the temporal model are parameters trained by the training unit 10 and stored in the parameter storage unit 17.

The time-series data is stored in the time-series data storage unit 21 and acquired by the time-series data input unit 22. The region data is stored in the region data storage unit 23 and acquired by the region data input unit 24.

Further, the output data in the inference unit 20 is future time-series data.

Ŷ∈ [symbol] ^{L′×T′} [Math. 17]

The above expression is established. This L′ means a region different from that at the time of processing by the training unit 10, and T′ means a time different from that at the time of processing by the training unit 10.

The inference unit 20 performs the following processing of (1) to (5) so that the output data can be obtained for the input data. The processing of (3) by the inference unit 20 is repeated for a predetermined number of epochs.

(1) The spatial/temporal factor calculation unit 25 of the inference unit 20 performs initialization processing of the spatial factor U₁ and the temporal factor U₂ by CP decomposing the time-series data Y acquired by the time-series data input unit 22 into the spatial factor U₁ and the temporal factor U₂ as in Equation (3) above.

(2) Upon receiving the result of the CP decomposition in the above (1), the spatial/temporal factor calculation unit 25 performs the following process (3) to perform tensor decomposition on the time-series data Y to calculate the spatial factor U₁ and the temporal factor U₂. By the processing of (2), the spatial factor for each region to which the region data is added can be calculated.

(3) Similarly to the above (2) of the processing by the training unit 10, the spatial/temporal factor calculation unit 25 updates the spatial factor U₁, the temporal factor U₂, and the background spatial factor X, respectively, based on the loss function of the matrix decomposition, the loss function of the spatial model, and the loss function of the temporal model, according to Equation (4), (5), and (6) above.

The loss function of the spatial model used in the above (3) in the inference unit 20 is a loss function using the parameters of the spatial model and the background spatial factor stored in the parameter storage unit 17 of the training unit 10, and the loss function of the temporal model used in the above (3) in the inference unit 20 is a loss function using the parameters of the temporal model stored in the parameter storage unit 17 of the training unit 10.

(4) After the update by the above (3) is completed, the spatial/temporal factor calculation unit 25 predicts a future temporal factor from the temporal model “τ_{T}(X,A,Θ_{T})” according to Equation (10) below. The future temporal factor corresponds to the left side of Equation (10).

[Math. 18]

Û₂=τ_{T}(U₂,Θ_{T}) Equation (10)

(5) The spatial/temporal factor synthesis unit 26 calculates future time-series data according to Equation (11) below from the spatial factor U₁ updated up to the above (3) in the inference unit 20 and the future temporal factor U₂ calculated in the above (4) in the inference unit 20, and stores the calculated time-series data in the future time-series data storage unit 27. The future time-series data corresponds to the left side of Equation (11). As described above, the processing by the Inference unit 20 of the time-series data prediction device 100 ends.

[Math. 19]

Ŷ=U₁·Û₂ Equation (11)

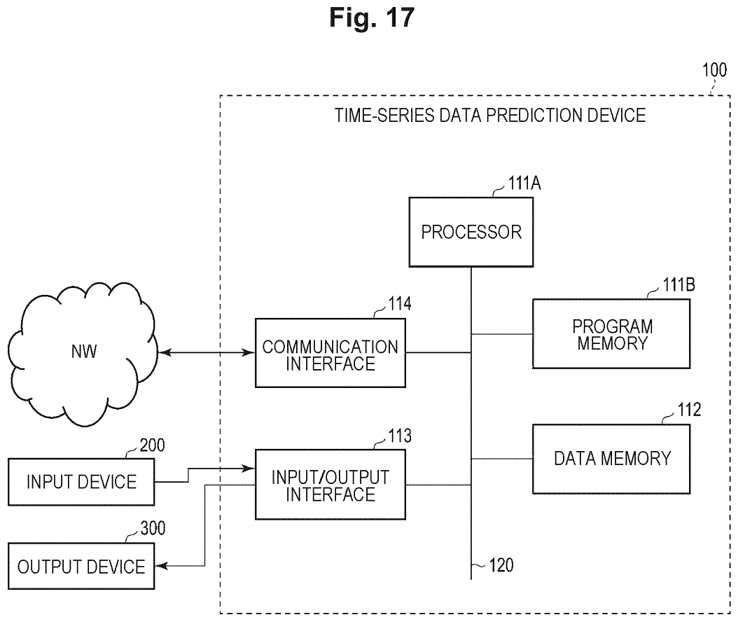

FIG. 17 is a block diagram illustrating an example of a hardware configuration of the time-series data prediction device according to an embodiment of the present invention.

In the example illustrated in FIG. 17, the time-series data prediction device 100 according to the above embodiment includes, for example, a server computer or a personal computer, and includes a hardware processor 111A such as a central processing unit (CPU). Then, a program memory 111B, a data memory 112, an input/output interface 113, and a communication interface 114 are connected to the hardware processor 111A via a bus 120.

The communication interface 114 includes, for example, one or more wireless communication interface units, and enables transmission and reception of information to and from the communication network NW. As the wireless interface, for example, an interface employing a low-power wireless data communication standard such as a wireless local area network (LAN) is used.

An input device 200 (device) and an output device 300 for an operator attached to the time-series data prediction device 100 are connected to the input/output interface 113.

The input/output interface 113 performs processing of fetching operation data input by an operator through the input device 200 such as a keyboard, a touch panel, a touchpad, or a mouse, and outputting output data to the output device 300 including a display device using liquid crystal, organic electro-luminescence (EL), or the like to display the output data. Note that, as the input device 200 and the output device 300, a device built in the time-series data prediction device 100 may be used, and an input device and an output device of another information terminal that can communicate with the time-series data prediction device 100 via a network NW may be used.

A program memory 111B is used as a non-transitory tangible storage medium, for example, in a combination of non-volatile memory enabling writing and reading at any time, such as a hard disk drive (HDD) or a solid state drive (SSD), and non-volatile memory such as read only memory (ROM), and stores programs necessary for executing various control processing according to an embodiment.

The data memory 112 is used as a tangible storage medium, for example, in a combination of the non-volatile memory described above and volatile memory such as random access memory (RAM), and is used to store various types of data acquired and created in the process of performing various types of processing.

The time-series data prediction device 100 according to an embodiment of the present invention can be configured as a data processing device including, as processing function units by software, the time-series data input unit 12, the spatial/temporal factor initialization unit 13, the region data input unit 15, and the spatial/temporal factor update unit 16 in the training unit 10 illustrated in FIG. 1, and including the time-series data input unit 22, the region data input unit 24, the spatial/temporal factor calculation unit 25, and the spatial/temporal factor synthesis unit 26 in the inference unit 20 illustrated in FIG. 1.

The time-series data storage unit 11, the region data storage unit 14, and the parameter storage unit 17 in the training unit 10, and the time-series data storage unit 21, the region data storage unit 23, and the future time-series data storage unit 27 in the inference unit 20 can be configured by using the data memory 112 illustrated in FIG. 11. However, these regions are not essential configurations in the time-series data prediction device 100, and may be regions provided in, for example, an external storage medium such as universal serial bus (USB) memory or a storage device such as a database server arranged in a cloud.

All of the processing function units in the time-series data input unit 12, the spatial/temporal factor initialization unit 13, the region data input unit 15, and the spatial/temporal factor update unit 16 in the training unit 10, and the time-series data input unit 22, the region data input unit 24, the spatial/temporal factor calculation unit 25, and the spatial/temporal factor synthesis unit 26 in the inference unit 20 can be realized by causing the hardware processor 111A to read and execute the program stored in the program memory 111B. Note that some or all of these processing function units may be implemented in other various forms including an integrated circuit such as an application specific integrated circuit (ASIC) or a field-programmable gate array (FPGA).

In addition, the method described in each embodiment can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as a program (software means) that can be executed by a computer, and can be distributed by being transmitted through a communication medium. Note that the programs stored on the medium side also include a setting program for configuring, in the computer, a software means (including not only an execution program but also tables and data structures) to be executed by the computer. The computer that realizes the present device executes the above-described processing by reading the programs recorded in the recording medium, constructing the software means by the setting program as needed, and controlling the operation by the software means. Note that the recording medium described in the present specification is not limited to a recording medium for distribution, but includes a storage medium such as a magnetic disk or a semiconductor memory provided in the computer or in a device connected via a network.

Note that the present invention is not limited to the foregoing embodiments and various modifications can be made in the implementation stage without departing from the gist of the invention. In addition, each embodiment may be implemented in appropriate combination, and in that case, combined effects can be obtained. Furthermore, the embodiment described above includes various inventions, and various inventions can be extracted by a combination selected from a plurality of disclosed components. For example, even if some components are deleted from all the components described in the embodiment, in a case where the problem can be solved and the effects can be obtained, a configuration from which the components are deleted can be extracted as an invention.

### REFERENCE SIGNS LIST

100 Time-series data prediction device
10 Training unit
11, 21 Time-series data storage unit
12, 22 Time-series data input unit
13 Spatial/temporal factor initialization unit
14, 23 Region data storage unit
15, 24 Region data input unit
20 Inference unit
25 Spatial/temporal factor calculation unit
26 Spatial/temporal factor synthesis unit
27 Future time-series data storage unit

1. A time-series data prediction device comprising:
first input circuitry that inputs geographically and spatially dispersed first time-series data;
second input circuitry that inputs first region data indicating a geographical region, the first region data being related to the first time-series data input by the first input circuitry;
initialization circuitry that performs initialization processing of a first spatial factor and a first temporal factor by decomposing the first time-series data input by the first input circuitry into the first spatial factor that is a spatial factor indicating a space related to the first time-series data and the first temporal factor that is a temporal factor indicating a time related to the first time-series data;
acquisition configured to
acquire a second spatial factor that is a spatial factor related to an entire space,
acquire a parameter of a spatial model that inputs the first spatial factor and the first region data and outputs a second spatial factor obtained by adding the first region data to the first spatial factor, and
acquire a parameter of a temporal model that inputs the first temporal factor and outputs a future temporal factor;
first update configured to
update the first spatial factor initialized by the initialization circuitry, the first temporal factor initialized by the initialization circuitry, and the second spatial factor acquired by the acquisition circuitry based on a loss function of the first time-series data, a loss function of the spatial model, and a loss function of the temporal model,
update a parameter of the spatial model based on the loss function of the spatial model, and
update the parameter of the temporal model based on the loss function of the temporal model;
third input circuitry that inputs geographically and spatially dispersed second time-series data to be estimated for future time-series data;
fourth input circuitry that inputs second region data indicating a geographical region, the second region data being related to the second time-series data input by the third input circuitry;
second initialization circuitry that performs initialization processing of a third spatial factor and a second temporal factor by decomposing the second time-series data input by the third input circuitry into the third spatial factor that is the spatial factor indicating a space related to the second time-series data and the second temporal factor that is a temporal factor indicating a time related to the second time-series data;
second acquisition circuitry that acquires a fourth spatial factor related to the second time-series data, the fourth spatial factor being a spatial factor related to an entire space;
second update circuitry that updates (1) the initialized third spatial factor, (2) the initialized second temporal factor, and (3) the acquired fourth spatial factor based on a loss function of the second time-series data, a loss function of the spatial model based on a parameter of the spatial model updated by the first update circuitry and the second spatial factor updated by the first update circuitry, and a loss function of the temporal model based on a parameter of the temporal model updated by the first update circuitry; and
estimation circuitry that predicts a future temporal factor based on a result updated by the second update circuitry and estimates the future time-series data based on the predicted temporal factor and the third spatial factor updated by the second update circuitry.

2. The time-series data prediction device according to claim 1, wherein:
the loss function of the spatial model used by the first update circuitry is
a loss function based on the second spatial factor, the first region data, an autoregressive model based on a parameter of the spatial model, and the first spatial factor,
the loss function of the temporal model used by the first update circuit is
a loss function based on an autoregressive model based on parameters of the first temporal factor and the temporal model, and the first temporal factor,
the loss function of the spatial model used by the second update circuitry is
a loss function based on the fourth spatial factor, the second region data, an autoregressive model based a parameter of the spatial model, and the third spatial factor, and
the loss function of the temporal model used by the second update circuitry is
a loss function based on an autoregressive model based on parameters of the second temporal factor and the temporal model and the second temporal factor.

3. A learning device comprising:
a first input circuitry that inputs geographically and spatially dispersed first time-series data;
a second input circuitry that inputs first region data indicating a geographical region, the first region data being related to the first time-series data input by the first input circuitry;
an initialization circuitry that performs initialization processing of the first spatial factor and the first temporal factor by decomposing the first time-series data input by the first input circuitry into a first spatial factor that is a spatial factor indicating a space related to the first time-series data and a first temporal factor that is a temporal factor indicating a time related to the first time-series data;
an acquisition circuitry that
acquires a second spatial factor that is a spatial factor related to an entire space,
acquires a parameter of a spatial model that inputs the first spatial factor and the first region data and outputs a second spatial factor obtained by adding the first region data to the first spatial factor, and
acquires a parameter of a temporal model that inputs the first temporal factor and outputs a future temporal factor; and
an update circuitry that
updates the first spatial factor initialized by the initialization circuitry, the first temporal factor initialized by the initialization circuitry, and the second spatial factor acquired by the acquisition circuitry based on a loss function of the first time-series data, a loss function of the spatial model, and a loss function of the temporal model,
updates a parameter of the spatial model based on a loss function of the spatial model, and
performs learning processing of updating a parameter of the temporal model based on a loss function of the temporal model.

4. An estimation device using a processing result from update circuitry of the learning device according to claim 3, the estimation device comprising:
a third input circuitry that inputs geographically and spatially dispersed second time-series data to be estimated for future time-series data;
a fourth input circuitry that inputs a second region data indicating a geographical region, the second region data being related to the second time-series data input by the third input circuitry;
a second initialization circuitry that performs initialization processing of the third spatial factor and the second temporal factor by decomposing the second time-series data input by the third input circuitry into a third spatial factor that is a spatial factor indicating a space related to the second time-series data and a second temporal factor that is a temporal factor indicating a time related to the second time-series data;
a second acquisition circuitry that acquires a fourth spatial factor related to the second time-series data, the fourth spatial factor being a spatial factor related to an entire space;
a second update circuitry that updates each of (1) the initialized third spatial factor, (2) the initialized second temporal factor, and (3) the acquired fourth spatial factor based on a loss function of the second time-series data, a loss function of the spatial model based on a parameter of the updated spatial model and the updated second spatial factor, and a loss function of the temporal model based on a parameter of the updated temporal model; and
an estimation circuitry that predicts a future temporal factor based on a result updated by the second update circuitry and estimates the future time-series data based on the predicted temporal factor and the third spatial factor updated by the second update circuitry.

5. A time-series data prediction method, comprising:
inputting geographically and spatially dispersed first time-series data;
inputting first region data indicating a geographical region, the first region data being related to the input first time-series data;
performing first initialization that is initialization of a first spatial factor and a first temporal factor by decomposing the input first time-series data into the first spatial factor that is a spatial factor indicating a space related to the first time-series data and the first temporal factor that is a temporal factor indicating a time related to the first time-series data;
acquiring a second spatial factor that is a spatial factor related to an entire space,
acquiring a parameter of a spatial model that inputs the first spatial factor and the first region data and outputs a second spatial factor obtained by adding the first region data to the first spatial factor, and
acquiring a parameter of a temporal model that inputs the first temporal factor and outputs a future temporal factor;
updating the initialized first spatial factor, the initialized first temporal factor, and the acquired second spatial factor based on a loss function of the first time-series data, a loss function of the spatial model, and a loss function of the temporal model,
updating a parameter of the spatial model based on the loss function of the spatial model, and
updating the parameter of the temporal model based on the loss function of the temporal model;
inputting geographically and spatially dispersed second time-series data to be estimated for future time-series data;
inputting second region data indicating a geographical region, the second region data being related to the second time-series data;
performing second initialization that is initialization of a third spatial factor and a second temporal factor by decomposing the second time-series data into the third spatial factor that is the spatial factor indicating a space related to the second time-series data and the second temporal factor that is a temporal factor indicating a time related to the second time-series data;
acquiring a fourth spatial factor related to the second time-series data, the fourth spatial factor being a spatial factor related to an entire space;
updating (1) the initialized third spatial factor, (2) the initialized second temporal factor, and (3) the acquired fourth spatial factor based on a loss function of the second time-series data, a loss function of the spatial model based on a parameter of the updated spatial model and the updated second spatial factor, and a loss function of the temporal model based on a parameter of the updated temporal model; and
predicting a future temporal factor based on a result updated and estimating the future time-series data based on the predicted temporal factor and the updated third spatial factor.

6. The time-series data prediction method according to claim 5, wherein:
the loss function of the spatial model used in the first initialization is
a loss function based on the second spatial factor, the first region data, an autoregressive model based on a parameter of the spatial model, and the first spatial factor,
the loss function of the temporal model used in the first initialization is
a loss function based on an autoregressive model based on parameters of the first temporal factor and the temporal model, and the first temporal factor,
the loss function of the spatial model used in the second initialization is
a loss function based on the fourth spatial factor, the second region data, an autoregressive model based a parameter of the spatial model, and the third spatial factor, and
the loss function of the temporal model used in the second initialization is
a loss function based on an autoregressive model based on parameters of the second temporal factor and the temporal model and the second temporal factor.

7. A non-transitory computer readable medium storing a time-series data prediction processing program for causing a processor to function as each circuitry of the time-series data prediction device according to claim 1.

8. A non-transitory computer readable medium storing a time-series data prediction processing program for causing a processor to perform the method of claim 5.
